(19) United States
(12) Patent Application Publication
(10) Pub. No.: US 2008/0217378 A1
(43) Pub. Date: Sep. 11, 2008

(54) Device for Centering and Clamping Tubular Parts, Comprising Means for the Real-Time Mesurement and Regulation of the Moisture Content

(76) Inventors: Gilles Richard, Silly Le Long (FR); Eric L'Arvor, Villers-Cotterets (FR)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 11/915,026

(22) PCT Filed: May 22, 2006
(86) PCT No.: PCT/FR2006/001159

§ 371 Date: May 26, 2008

(30) Foreign Application Priority Data
May 20, 2005 (FR) 0505078

(51) Int. Cl. B23K 37/053; B23K 9/16; B23K 9/028; B23K 9/32

(52) U.S. Cl. 228/102; 269/47; 228/8

(57) ABSTRACT

The invention relates to a device for centring and clamping conduits which are preferably made from alloy steel and which are positioned end to end in order to be welded to form a pipeline. The invention comprises: means for centring and clamping two conduits that are to be welded, optional leak-tight patition means which define an inerting chamber at the mating surface, and inert gas distribution means for creating a protective atmosphere at the mating surface. The inventive device also comprises at least means for the real-time measurement of the moisture content of the protective atmosphere and means (3) for the real-time regulation of the moisture content as a function of said measurements, such that the moisture content of the atmosphere is maintained below a pre-determined threshold value.

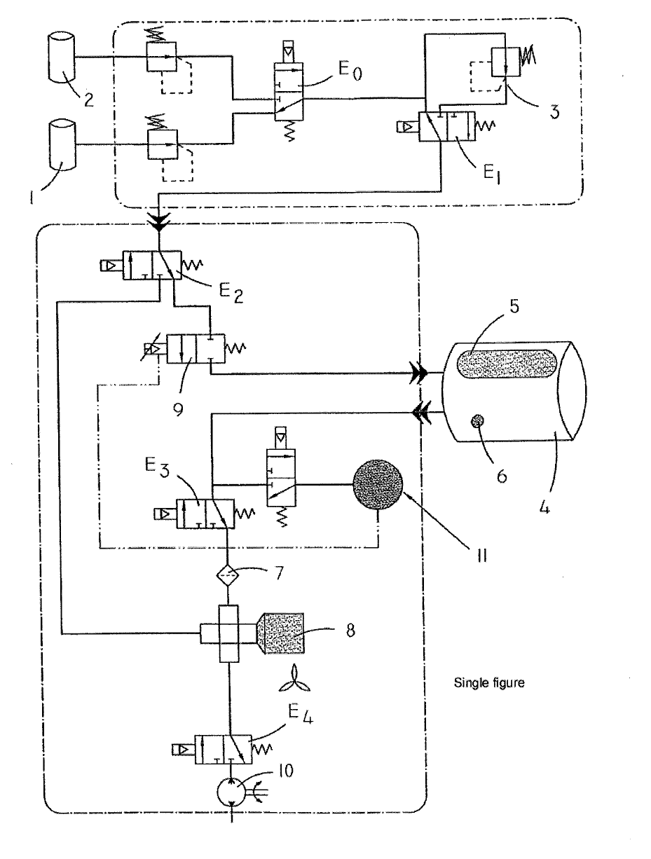

The present invention relates to a device for centering and clamping tubular parts, such as pipes made of alloy steel, placed end to end in order to be welded to form a corrosion-resistant pipeline for the transport of gas, petroleum or water.

In the construction of a pipeline, the end of one pipe is placed at the extremity of the pipeline under construction in order to weld them together. It is thus possible to construct a pipeline of the desired length by simple addition of pipes. The exterior welding device is generally arranged for relocation along the pipeline so constructed and to make the welds as needed, while a device inside the pipeline is likewise relocated inside the latter.

This internal device, when a new pipe to be welded is put in place, makes it possible to align the axis of this pipe perfectly with that of the pipeline under construction and therefore to align the respective extremities of the pipe and the pipeline with precision for the purpose of welding, as well as to keep them in this alignment during the welding operation. A centering and clamping device of this type is commonly called a “clamp” and is described in particular in EP 0,249,079, EP 1,123,774 and EP 0,767,719.

The welding device found positioned on the outside of the stainless steel or alloy steel pipes then deposits the welding layer or layers on the outside. At the time of the first layer, called the penetration layer, it is important that the fusion bath not come into contact with an active, i.e., non-inert gas, such as air or oxygen, so as to prevent oxidation from taking place when they are heated to welding temperatures. As a matter of fact, if welding is performed in an atmosphere containing oxygen, the pipeline produced is then susceptible to much more rapid corrosion. Therefore, so as to protect the fusion bath, the exterior welding device comprises means permitting the production of gaseous protection by bringing in, opposite the weld, inert gas for protecting the said fusion bath.

However, it has been noted that this exterior protection is insufficient. In effect, as the penetration layer is produced, the fusion bath behind the weld comes into contact with an atmosphere not free of oxygen. A device for internal centering and clamping provided with means creating a leak-tight chamber at the surface between the two pipes and purging the oxygen contained in this chamber while introducing an inert gas such as argon to create an inert atmosphere at the weld has therefore been proposed in EP 0,193,812. So as to maintain this protective atmosphere throughout the welding operation, the flow of argon is kept continuous in the leak-tight chamber. Such a device thus makes it possible to produce an atmosphere free of oxygen behind the weld.

However, a device of this type has at least two major disadvantages in that:
it requires a very high consumption of inert gas, the flow of inert gas being continuous during the entire welding operation to guarantee this protective atmosphere. This consumption not only results in high cost but also requires great reserves of inert gas, in order to avoid problems of gas supply and of space required for the device,
too high a moisture content may produce imperfections when the first layer of the welding sequence is laid down, where these imperfections may be porosities, frothy/oxidized appearance or concavity. Depending upon the nature and dimensions of these imperfections, they may result in extremely costly repairs.

Document U.S. Pat. No. 5,425,492 proposes a purge device by which a purge gas is introduced at a weld to be made in order to exhaust in particular the reactive gases in a defined interior space at the weld. So as to maintain an effective flow of purge gas, the pressure in the interior space is measured and the measured values are sent to a control that incrementally adjusts the discharge of the gas into the interior space. However, the interior space at the mating surface is vast and emission of the purge gas does not occur opposite the mating surface but at the extremities of this interior space, so that the flow of purge gas is laminar and extends along the walls of the interior space up to the weld. Consequently, despite the proposed regulation, the consumption of purge gas remains great in order to maintain an effective protective atmosphere. Moreover, since measurement of the pressure is made at the extremities of the space so defined and in the vicinity of the means of emission of the purge gas, it may also be assumed that it does not reflect the pressure at the mating surface, which cannot result in effective regulation in real time. Similarly, there is no question of measuring the moisture content.

U.S. Pat. No. 4,541,055 discloses a device for machining parts by laser and in particular a computer control device for the said machining, in which a machining chamber receives the part to be machined as well as a non-reactive gas, the entry flow rate of which is monitored. A check is made of the oxygen and the moisture content from the measurement of the oxygen and water content in the chamber, but these measurements are not aimed at producing regulation of the flow rate or pressure of the purge gas, just at defining a state permitting or not permitting welding, the flow rate of the gas being fixed for each of the welding phases. Consequently, when the moisture content is detected greater than a specified level, laser welding is prevented. Moreover, the conditions of this laser welding process are very far from those of welding pipes end to end in order to construct pipelines.

To overcome these disadvantages, the present invention proposes a centering and clamping device making it possible to produce a protective atmosphere for the weld inside the pipes to be welded but which also makes it possible to monitor and regulate the said protective atmosphere in order to guarantee optimal conditions.

Therefore, the subject of the present invention is a centering and clamping device for pipes, preferably made of alloy steel, placed end to end to be welded and to form a pipeline, comprising in particular means for centering and clamping two pipes to be welded, optionally leak-tight partition means which define an inerting chamber at the mating surface and means for distribution of an inert gas for creating a protective atmosphere at the mating surface, characterized in that it in addition comprises at least means for real-time measurement of the moisture content of the protective atmosphere and means for real-time regulation of the said moisture content as a function of the said measurements, so as to maintain the moisture content of the atmosphere below a predetermined threshold value.

Thus, the device advantageously makes it possible to define and maintain optimal welding conditions (protective atmosphere free of moisture).

This gaseous protection behind the weld makes it possible to obtain optimal penetration-layer quality, regardless of the welding process used, such as by MIG/MAG fusible electrode arc, refractory electrode arc, etc., by regulating the flow rate of the inert gas and/or the supply pressure of the inert gas, so as to maintain the moisture content of the protective atmosphere below the predetermined threshold value, in order to guarantee good conditions for welding without however requiring continuous distribution of the inert gas. Thus, the device advantageously is economical while at the same time helping to improve the profile of the penetration layer

The data measured for the moisture content are recorded and processed in real time so as to regulate the supply pressure and/or the flow rate of the inert gas in real time, and the data may likewise be transferred to a command and control unit outside the pipeline under construction by telegraphic, infrared, radio transmission or any other suitable means.

According to a first variant of embodiment of the invention, the device advantageously comprises means for real-time processing of measurements of moisture content and the means for regulation of the moisture content are comprised of means for real-time regulation of the flow rate and/or the supply pressure of the inert gas, processing of the said information (measurements) making it possible to determine, in real time, the instructions to be sent to the said means for regulation in order to maintain the moisture content below the predetermined alarm threshold if necessary.

According to a second variant of embodiment of the device according to the invention, the latter comprises means for real-time processing of measurements of the moisture content, and as means for real-time regulation of the moisture content, means for dehumidification of the protective atmosphere, such as for example means for introduction of salts into the said atmosphere, means for heating associated with means for removal of moisture.

The device then advantageously comprises means for command of the said dehumidifying means, actionable in real time as a function of the moisture content measured in the inerting chamber.

Instructions to the means for regulation may be sent by telegraphic electrical connection, by radio transmission, by infrared or any other suitable means of transmission.

According to a particularly advantageous embodiment of the invention, the means for regulation of the flow rate of inert gas and/or the supply pressure of this inert gas likewise function depending on the O₂ content measured in the said protective atmosphere, so as to maintain the O₂ content of the atmosphere below a predetermined alarm threshold value.

For this purpose, the device likewise comprises means for real-time measurement of the O₂ content within the protective atmosphere, for example confined to the interior of the inerting chamber, and means for processing, preferably in real time, measurements of the O₂ content, where processing of the said information (measurements) makes it possible to determine instructions for command of the means for regulation of the flow rate and/or the supply pressure of the inert gas in order to maintain the O₂ content below the predetermined alarm threshold if necessary. Preferably, the alarm threshold value of the O₂ content is 5000 ppm.

Similarly, means may likewise be provided for real-time measurement of the pressure, such as a pressure pick-up permitting measurement of the pressure within the protective atmosphere, and means for real-time processing of the pressure measurements, where processing of the said information (measurements) makes it possible to determine the instructions for command of the means for regulation of the flow rate and/or the supply pressure of the inert gas in order to maintain the pressure below the predetermined alarm pressure. The pressure alarm threshold value preferably is 12 millibars.

To the predetermined alarm threshold value below which the moisture content should be, preferably 60%, may be added a start-of-cycle threshold value, below the alarm threshold value, so that the welding cycle only commences at a moisture content below this start-of-cycle threshold value. Similarly, there may be provided a safety threshold value, greater than the alarm threshold value, which, if it is reached, produces the command for means of automatic arrest of welding for the purpose of total arrest of the welding cycle. The same applies for the O₂ content and the pressure.

Preferably, therefore, when the means for measurement of the moisture content and optionally those for the O₂ content and/or the pressure detect moisture content, O₂ content, pressure values below predetermined alarm threshold values and preferably below start-of-cycle threshold values, means for command of welding on the outside are activated and the welding cycle is started. The welding cycle then proceeds as long as the moisture and optionally the O₂ content and pressure values measured remain below the alarm threshold values. If, during welding, the means for regulating the flow rate and/or the supply pressure of the inert gas do not permit moisture content and optionally 02 content and pressure values below alarm threshold values to be maintained and if the duration of exceedance of the alarm threshold is below a predetermined interval of time, means may be provided for transmission of an error message to the command and control unit of the outside welding station.

If the duration of exceedance of the alarm threshold exceeds the predetermined time, then means for the automatic arrest of welding are activated and the welding cycle can be automatically interrupted.

Instructions to the regulating means may be sent by electrical telegraphic connection, by radio transmission, by infrared or by any other suitable means of transmission.

The processing means preferably comprise at least means for recording the alarm threshold value, the start-of-cycle threshold value and the safety threshold value, as well as means for comparisons of the measurements made with the recorded values. The threshold values may thus be selected by the user and programmed as a function of the environment and the operating conditions.

The leak-tight partition means which define the inerting chamber preferably are composed of seals such as inflatable seals, lip seals or other, or of inflatable rubber rings. This inerting chamber advantageously makes it possible to reduce the volume of inert gas to be diffused in order to obtain the gaseous protection sought, on the one hand, and to reduce the duration in order to reach this predefined content and/or pressure, also called inerting duration, on the other.

Means for measuring the temperature may be provided in the inerting chamber, in particular for measuring the ambient temperature in which the moisture content pick-up works, and to verify that this temperature is compatible with the range of use of the pick-up.

According to a preferred form of the device according to the invention, the means for distribution of inert gas are located on the device in such a way that this distribution takes place directly behind the mating surface, at a radial distance relative to the inner skin of the extremities to be welded of at most 30 mm, the distribution means being of the tube/coil type provided with a plurality of exhaust openings or orifices or of porous metallic sheet type (porous steel), permitting homogeneous diffusion of the inert gas in the direction of the mating surface.

According to a variant of the device according to the invention, the latter is equipped with means for verification of the calibration of the means for measuring the moisture content, comprising an additional inert gas supply, the inert gas of this second supply being calibrated for moisture for example at 40%, and preferably contained in a bottle outside the device and conducted to the latter by a pipe connected directly to the means for measuring the moisture content, and means permitting switching from one supply to the other so that, when the inert gas calibrated for moisture very briefly passes the measuring means, calibration of the measuring means can be verified.

A device according to the invention is usable in any position of the pipes to be welded, pipes horizontal for welding on land or in the sea with placement in shallow water, or vertical for welding in the sea in deep water.

The device according to the invention may likewise comprise a supporting strip on the back for maintaining the fusion bath at the time of the penetration phase, where this strip may be made of ceramic materials or of a metallic material such as copper or a copper alloy.

The invention likewise relates to a process for implementation of the device according to the invention, wherein once the said device, introduced into the interior of two pipes to be welded, has centered and clamped the said pipes, an inert gas is distributed at the mating surface between the latter so as to create a protective atmosphere behind the mating surface, characterized in that the moisture content prevailing within the protective atmosphere is measured in real time, the said measurements made are compared relative to a predetermined moisture-content alarm threshold value, and then the moisture content is regulated in real time so as to maintain it below the predetermined alarm threshold.

The invention will now be described in greater detail with reference to the drawing, in which the single figure represents a device according to the invention schematically. As can be seen schematically in the single figure, the device comprises means for distribution of an inert gas comprising an inert gas supply 1 as well as a standard gas supply 2. A first electromagnetic valve E0 makes it possible to select one or the other of the supplies. In the single figure, the distribution of inert gas has been selected so as to create a protective atmosphere at the mating surface.

Pressure-regulating means 3 are then provided. In the diagram represented, a second electromagnetic valve E1 guides the inert gas directly to a third electromagnetic valve E2, which sends the gas to the inerting chamber 4 created at the mating surface. A temperature pick-up 5, as well as a moisture pick-up 6, is provided in this chamber 4.

By means of an electromagnetic valve E3, the gas is guided to a cell 8 for measurement of the O₂ content. A filter 7 may be positioned before the cell 8. When the cell 8 detects an O₂ content greater than the predetermined alarm threshold, the pressure regulator 9 is commanded in return.

The cell 8 is likewise connected to an auxiliary pump 10 by way of an electromagnetic valve E4.

This auxiliary pump 10 makes it possible to verify that the gas analyzed by the cell 8 is indeed representative of the gas contained in the chamber 4, the pump 10 allowing creation of a controlled depression downstream of the cell 8, in order to guarantee a minimum flow rate.

A pressure pick-up 11 may likewise be provided.

The invention of course is not limited to the given embodiment described above but, on the contrary, covers all variants, in particular as concerns selection of alarm threshold values, which are determined as a function of welding conditions and of the environment in which welding takes place.

1. Centering and clamping device for pipes, preferably made of alloy steel, placed end to end to be welded and to form a pipeline, comprising in particular means for centering and clamping two pipes to be welded, optionally leak-tight partition means which define an inerting chamber at the mating surface, and means for distribution of an inert gas in order to create a protective atmosphere at the mating surface,
characterized in that it in addition comprises at least means for real-time measurement of the moisture content of the protective atmosphere and means for real-time regulation of the said moisture content as a function of the said measurements, so as to maintain the moisture content of the atmosphere below a predetermined threshold value.

2. Device according to claim 1,
characterized in that it comprises means for processing measurements of the moisture content in real time, and the means for regulation of the moisture content in real time are comprised of means for regulation of the flow rate and/or the supply pressure of the inert gas, processing of the said information (measurements) making it possible to determine the instructions to be sent to the said means for regulation in order to maintain the moisture content below the predetermined threshold if necessary.

3. Device according to claim 1,
characterized in that it comprises mmeans for real-time processing of measurements of the moisture content and, as means for regulation of the moisture content in real time, means for dehumidification of the protective atmosphere, such as means for introduction of salts into the said atmosphere, heating means associated with means for removal of the moisture and any other suitable means.

4. Device according to claim 3,
characterized in that it comprises means for real-time command of the said dehumidifying means, actionable as a function of the moisture content measured in the protective atmosphere.

5. Device according to any of claims 1 to 4,
characterized in that the alarm threshold value of the moisture content is 60%, preferably 50%.

6. Device according to any of claims 1 to 5,
characterized in that it comprises welding command means activated when the moisture content is lower than a predetermined start-of-cycle threshold value, lower than the alarm threshold value.

7. Device according to any of claims 1 to 5,
characterized in that it comprises means for transmission of an error message to the command and control unit of the outside welding station when the moisture content is greater than the alarm threshold value and if the duration of exceedance of the threshold is below a predetermined interval of time.

8. Device according to claim 7,
characterized in that it comprises means for automatic arrest of welding, if the duration of exceedance of the alarm threshold exceeds the predetermined interval of time.

9. Device according to any of claims 1 to 8,
characterized in that it in addition comprises means for the real-time measurement of the O₂ content with the protective atmosphere and means for real-time processing of measurements of the O₂ content, processing of the said information (measurements) making it possible to determine the instructions for command of means for regulation of the flow rate and/or the supply pressure of the inert gas in order to maintain the O₂ content below a predetermined alarm threshold, preferably 5000 ppm.

10. Device according to any of claims 1 to 9,
characterized in that it in addition comprises means for the real-time measurement of the pressure, such as a pressure pick-up, making it possible to measure the pressure within the protective atmosphere, and means for the real-time processing of pressure measurements, processing of the said information (measurements) making it possible to determine the instructions for command of the means for regulation of the flow rate and/or the supply pressure of the inert gas in order to maintain the pressure below the predetermined alarm threshold, preferably 12 millibars.

11. Device according to any of claims 1 to 10,
characterized in that the means for measurement of the temperature are provided in the inerting chamber.

12. Device according to any of claims 1 to 11,
characterized in that the means for distribution of the inert gas are located on the device in such a way that this distribution takes place directly behind the mating surface, at a radial distance relative to the inner skin of the extremities to be welded of at most 30 mm, the means for distribution being of the tube/coil type provided with a plurality of exhaust openings or orifices, allowing the inert gas to be diffused homogeneously in the direction of the mating surface.

13. Process for implementation of the device according to the invention, wherein once the said device, introduced into the interior of two pipes to be welded, has centered and clamped the said pipes, an inert gas is distributed at the mating surface between the said pipes so as to create a protective atmosphere behind the mating surface,
characterized in that the moisture content prevailing within the protective atmosphere is measured in real time, the said measurements made are compared relative to a predetermined alarm threshold value of moisture content, and then the moisture content is regulated in real time so as to maintain it below the predetermined alarm threshold.
